(19) United States
(12) Patent Application Publication
(10) Pub. No.: US 2004/0196985 A1
(43) Pub. Date: Oct. 7, 2004

(54) Electronic apparatus having a detachable speaker unit

(75) Inventor: Shinji Kokubo, Tokyo (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/719,860

(22) Filed: Nov. 21, 2003

(30) Foreign Application Priority Data
Apr. 7, 2003 (JP) PCTJP0304401

(51) Int. Cl. H04R 29/00; H04B 5/00

(52) U.S. Cl. 381/79; 381/77

(57) ABSTRACT

An electronic apparatus has a main body, and a speaker unit detachably mounted to the main body. The speaker unit includes a speaker, a first wireless communication unit, and a D/A converter. The electronic apparatus also has a second wireless communication unit which transmits an audio digital signal to the first communication unit over a wireless cannel, a detector which detects whether or not the speaker unit is installed in said main body, and a controller which actuates the second wireless communication for transmitting the audio digital signal to the first communication unit when the detector detects that said speaker unit is not installed in said main body. The D/A converter converts the audio digital signal received by the first communication unit to an audio analog signal, and the speaker outputs sound on the basis of the audio analog signal.

### CROSS-REFERENCE TO RELATED APPLICATIONS

This application is based upon and claims the benefit of priority from PCT International Application No. PCT/JP03/04401, filed Apr. 7, 2003, the entire contents of which are incorporated herein by reference.

### BACKGROUND OF THE INVENTION

1. Field of the Invention

This invention relates to an electronic apparatus like a portable computer, having a speaker unit and an audio digital signal output method for the electronic device.

2. Description of the Related Art

Recently, a notebook portable computer has a speaker unit for alarm output and audio output. In this type of computer, the speaker unit is fixed to a casing thereof. Accordingly, the direction of the sound delivered from the speaker unit is fixed, and the position of the speaker unit is limited. When such a portable computer is developed to be smaller and thinner, it will be more difficult to install a speaker unit therein. Also, in a smaller and thinner notebook portable computer, since the installation state of the speaker unit is limited, it is hard to obtain good sound directivity and acoustic effect.

Japanese utility model application number 2-122017 (Japanese utility model publication number 4-78872) discloses a television with speaker units which are detachably mounted to the television. In this reference, the communications between the television and the speakers is carried out by using frequency modulation radio signals (analog signals).

However, as such an analog radio signal is easily affected by noises, it may be unsuitable in the case that high quality audio signals and/or content are transmitted. Also, the television receives electric power from a commercial power supply while a portable computer sometimes works by a battery. Therefore, this reference does not address the situation under which a main battery operated apparatus is provided with a detachable speaker.

### BRIEF SUMMARY OF THE INVENTION

Embodiments of the present invention provide an electronic apparatus having a speaker unit detachably mounted thereon.

According to an embodiment of the present invention, an electronic apparatus has a main body, and a speaker unit detachably mounted to the main body. The speaker unit includes a speaker, a first wireless communication unit, and a D/A converter. The electronic apparatus also has a second wireless communication unit which transmits an audio digital signal to the first communication unit over a wireless cannel, a detector which detects whether the speaker unit is not installed in said main body, and a controller which makes the second wireless communication transmit the audio digital signal to the first communication unit when the detector detects that said speaker unit is not installed in said main body. The D/A converter converts the audio digital signal received by the first communication unit to an audio analog signal, and the speaker outputs sound on the basis of the audio analog signal.

Additional features and advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a portable computer with detachable speaker units according to an embodiment of the present invention;

FIG. 2 is a block diagram showing hardware of the portable computer in the embodiment;

FIG. 3 is a flowchart showing an audio digital signal output operation performed in a main body according to the embodiment;

FIG. 4 is a flowchart showing a power supply operation from the main body to the speaker units according to the embodiment;

FIG. 5 is a flowchart showing an audio digital signal output operation of the speaker units according to the embodiment;

FIG. 6 is a flowchart showing a power supply operation in the speaker units according to the embodiment; and

FIG. 7 is a horizontal sectional view showing a mounting state of the speaker unit on the main body according to the embodiment.

### DETAILED DESCRIPTION

Preferred embodiments according to the present invention will be described hereinafter with reference to the accompanying drawings.

In the embodiments below, the electronic apparatus is explained using a notebook personal computer (hereinafter “personal computer”). The electronic apparatus may also be a portable game machine, a personal digital assistant (PDA), an audio device, and the like.

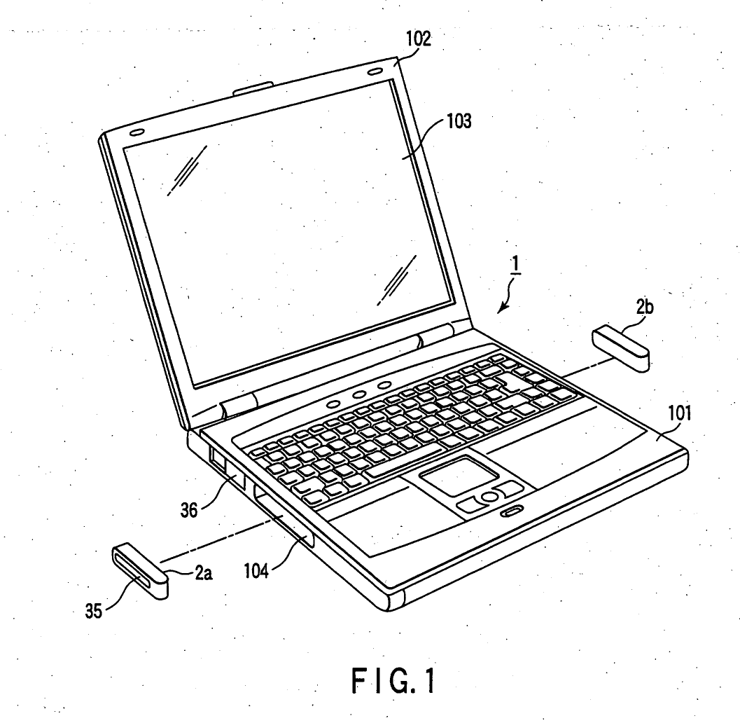

FIG. 1 shows the structure of the personal computer according to the embodiment.

The personal computer 1 has a main body 101 and a display unit 102. The display unit 102 incorporates a display device 103 which is a liquid crystal display (hereinafter “LCD”) supported by a casing. The display unit 102 incorporating the display device 103 is connected to the main body 101 rotatably between an open position and a closed position.

The main body 101 has compartments 104 formed on the right side surface and the left side surface, and detachable speaker units 2a, and 2b are installed in each compartment 104. The speaker units 2a, and 2b include loudspeakers (hereinafter “speaker”) 35 which output stereophonic sound.

The speaker units 2a, and 2b are detached from the main body 101 by manipulating a slider 36 formed on each side surface of the main body 101. The user can take out the speaker units 2a, and 2b from the main body 101 by sliding the slider 36 of the main body 101. The personal computer 1 may be also used without detaching the speaker units 2a, and 2b from the main body 101.

When the speaker units 2a, and 2b are detached from the main body 101, an audio digital signal is wirelessly transmitted from the main body 101 to the speaker units 2a, and 2b.

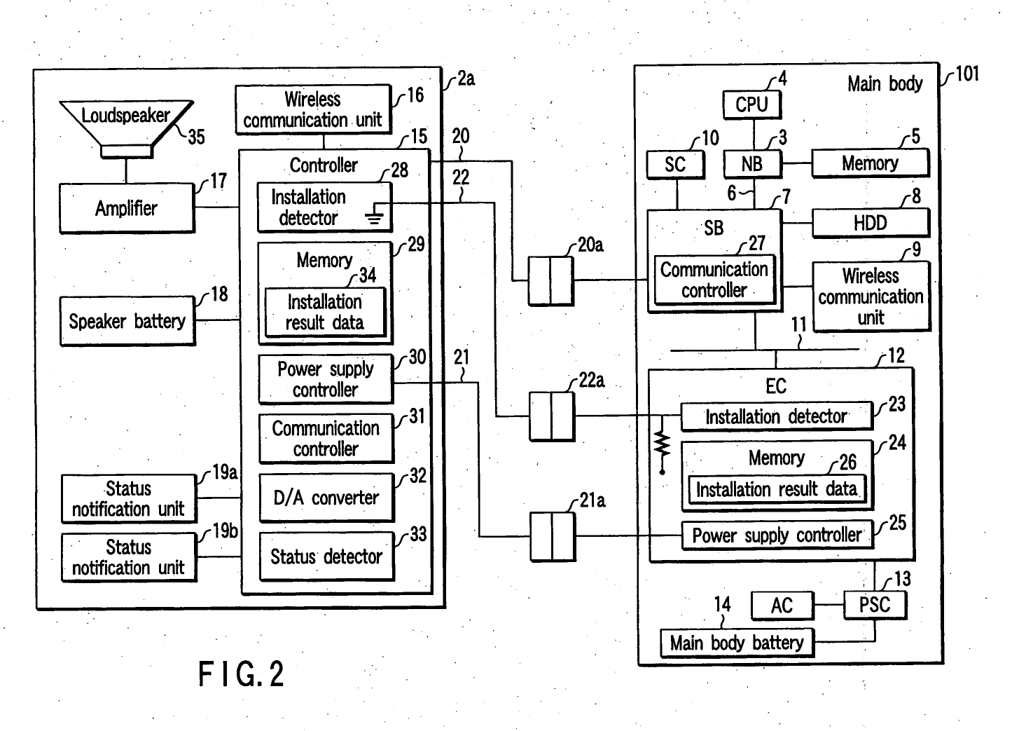

FIG. 2 shows hardware of the personal computer 1 according to the embodiment. In FIG. 2, the connection between the main body 101 and one speaker unit 2a is shown, but the connection is also the same between the main body 101 and other speaker unit 2b.

In the main body 101, a north bridge (hereinafter “NB”) 3 is connected to a central processing unit. (hereinafter “CPU”) 4, a memory 5, and a PCI bus 6.

A south bridge (hereinafter “SB”) 7 is connected to a PCI bus 6, a hard disk drive (hereinafter “HDD”) 8, a wireless communication unit 9, a sound controller (hereinafter “SC”) 10, and a low pin count (hereinafter “LPC”) bus 11.

An embedded controller (hereinafter “EC”) 12 is connected to the LPC bus 11 and a power supply controller (hereinafter “PSC”) 13.

The PSC 13, when receiving supply of electric power from an alternating-current power source (hereinafter “AC power source”) which is commercial power source, comprises functions of supplying the electric power from the AC power source to each device in the main body 101, and also charging a main body battery 15.

On the other hand, the PSC 13, when not receiving supply of electric power from the AC power source, supplies the electric power from the main body battery 15 to each device in the main body 101.

In the embodiment, a controller 15 of the speaker unit 2a is connected to a wireless communication unit 16, an amplifier 17, a speaker battery 18, and status notification units 19a, 19b containing LED, etc.

When the speaker unit 2a is installed in the main body 101, the controller 15 is connected to the SB 7 by way of an audio signal circuit 20 comprising a connector 20a.

When the speaker unit 2a is installed in the main body 101, power supply controller 30 and the installation detector 28 of the controller 15 are respectively connected to the EC 12 by way of a power supply circuit 21 comprising a connector 21a and an installation detection circuit 22 comprising a connector 22a.

That is, when the speaker unit 2a is detached from the main body 101, the connectors 20a, 21a, 22a are disconnected, and the audio signal circuit 20, power supply circuit 21, and installation detection circuit 22 are disconnected.

On the other hand, when the speaker unit 2a is installed in the main body 101, the connectors 20a, 21a, 22a are connected, and the audio signal circuit 20, power supply circuit 21, and installation detection circuit 22 are connected.

The EC 12 comprises an installation detector 23 to detect whether the speaker unit 2a is installed in the main body 101 or not, a memory 24 for recording the result of installation detection, and a power supply controller 25 for controlling power supply to the speaker unit 2a.

For example, the installation detector 23 provides specified power to the controller 15 by way of the installation detection circuit 22. The end of the controller 15 near the installation detection circuit 22 is grounded.

The installation detector 23 detects whether the speaker unit 2a is detached or not by detecting whether the installation detection circuit 22 is grounded or not, and records detection result data 26 showing the result of detection in the memory 24. The memory 24 comprises, for example, a register.

The power supply controller 25 provides the electric power to the controller 15 by way of the power supply circuit 21 when the installation result data 26 recorded in the memory 24 indicates installation.

The power supply controller 25 also stops power supply to the speaker unit 2a, when the main body 101 is operated by the electric power from the main body battery 14, in order to reduce power consumption of the main body battery 14.

The SB 7 includes a communication controller 27 for switching the output mode of an audio signal.

The communication controller 27 transmits the audio digital signal from the sound controller 10 to the controller 15 by way of the audio signal circuit 20 when the installation result data 26 in the memory 24 indicates installation.

On the other hand, when the installation result data 26 does not show installation, the communication controller 27 outputs the audio digital signal from the sound controller 10 by using the wireless communication unit 9. Between the wireless communication unit 9 and wireless communication unit 16, communication is established by, for example, Bluetooth®. The audio signal transmitted through Bluetooth® is a digital signal, therefore such a digital signal is resistant to interference which might adversely affect the sound output from speaker 35.

The controller 15 of the speaker unit 2a has an installation detector 28, a memory 29, a power supply controller 30, a communication controller 31, a D/A converter 32, and a status detector 33. As the installation detector 28 is the same structure as the installation detector 23 of the main body 1, its explanation will be omitted. Installation result data 34 showing the detection result by the installation detector 28 is recorded in the memory 29.

The power supply controller 30 supplies the electric power from the speaker battery 18 to each device in the speaker unit 2a when the installation result data 34 of the memory 29 does not show installation.

On the other hand, the power supply controller 30 supplies the electric power from the power supply circuit 21 to each device in the speaker unit 2a and charges the speaker battery 18 when the installation result data 34 shows installation.

The communication controller 31 sends the audio digital signal received from the audio signal circuit 20 to the D/A converter 32 when the installation result data 34 shows installation.

On the other hand, the communication controller 31 sends the audio digital signal received from the wireless communication unit 16 to the D/A converter 32 when the installation result data 34 does not show installation.

The D/A converter 32 converts the received audio digital signal from a digital to an analog signal, and sends the analog signal to the amplifier 17. The amplifier 17 amplifies the audio analog signal, and then the speaker 35 outputs the sound on the basis of the amplified signal from the amplifier 17.

The status detector 33 outputs the remaining power and charged state of the speaker battery 18, the radio wave received signal strength (i.e., amplitude) of the wireless communication, and possible others parameters by using status notification units 19a, 19b. The status notification units 19a, 19b comprise, for example, LED capable of emitting light in green and orange colors. The status detector 33 lights the LED of the status notice unit 19a in green when the radio wave signal strength of the wireless communication is above a predetermined level, and lights the LED in orange when the radio wave signal strength is below the predetermined level. Further, depending on the radio wave signal strength of the wireless communication, the status detector 33 may change the LED from a steady orange light to a blinking orange light.

Further, when the remaining power of the speaker battery 18 becomes lower than a specified level (for example, below 30%), the status detector 33 lights the LED of the status notification unit 19b in orange, and depending on the decline of remaining power (for example, below 15%), switches the LED from a steady state to a blinking state. Still further, when the remaining power of the speaker battery 18 becomes lower than a specified level (for example, below 2%), the status detector 33 executes a process for delivering a warning sound from the speaker 35.

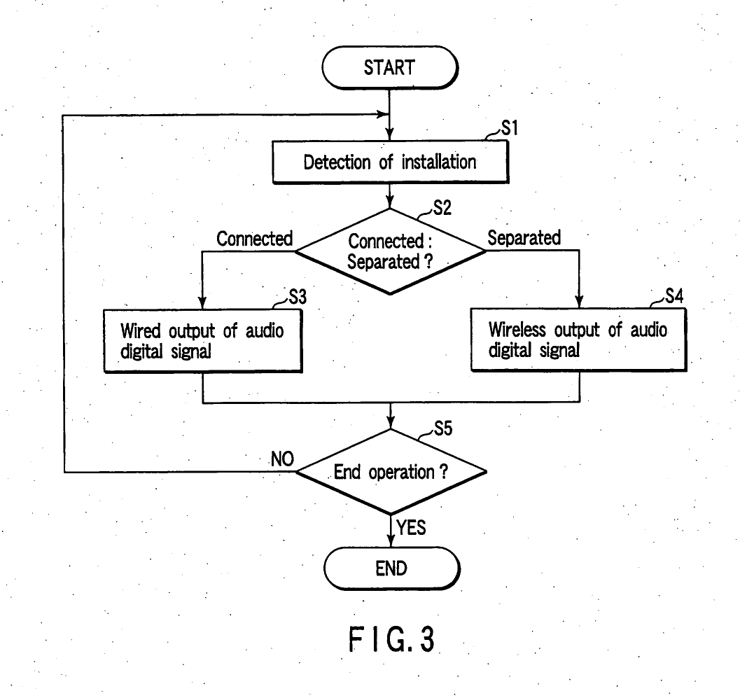

FIG. 3 shows a flow of an audio signal output operation of the main body 101.

In step S1, the installation detector 23 records installation result data 26 showing the result of detection of installation of the speaker unit 2a.

In step S2, the communication controller 27 determines whether the installation result data 26 shows installation or not.

If the installation result data 26 shows installation, the communication controller 27 sends an audio digital signal to the controller 15 by way of the audio signal circuit 20 in step S3.

On the other hand, if the installation result data 26 does not show installation, the communication controller 27 outputs an audio digital signal by using the wireless communication unit 9 in step S4.

In step S5, the main body 101 repeats this process until the operation has finished (i.e., the sound output function has completed).

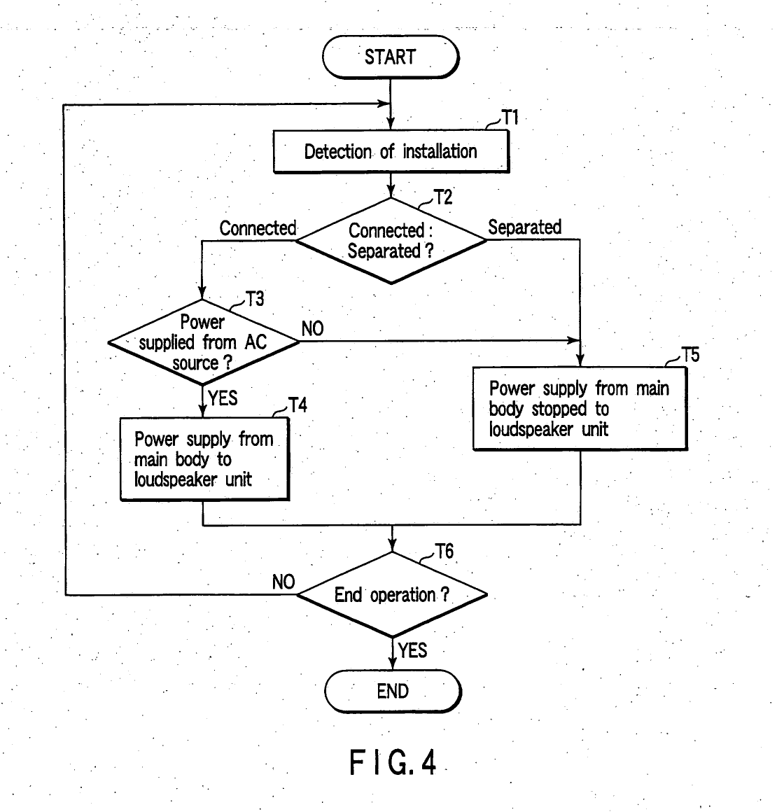

FIG. 4 shows a flow of a power supply operation from the main body 101 to the speaker unit 2a.

In step T1, the installation detector 23 records installation result data 26 showing the result of detection of installation of the speaker unit 2a.

In step T2, the power supply controller 25 determines whether the installation result data 26 shows installation or not.

If the installation result data 26 shows installation, the power supply controller 25 determines whether the main body 101 is operated by the electric power from the AC power source or not in step T3.

If the main body 101 is operated by the electric power from the AC power source, the power supply controller 25 supplies the power from the alternating-current power source to the speaker unit 2a by way of the power supply circuit 21 in step T4.

On the other hand, when the installation result data 26 does not show installation in step T2, or when the main body 101 is operated by the electric power from the main body battery 14 in step T3, the power supply controller 25 stops power supply to the speaker unit 2a in step T5. In this case, speaker battery 18 supplies power to the speaker unit 2a.

In step T6, the main body 101 repeats this process until the operation has finished.

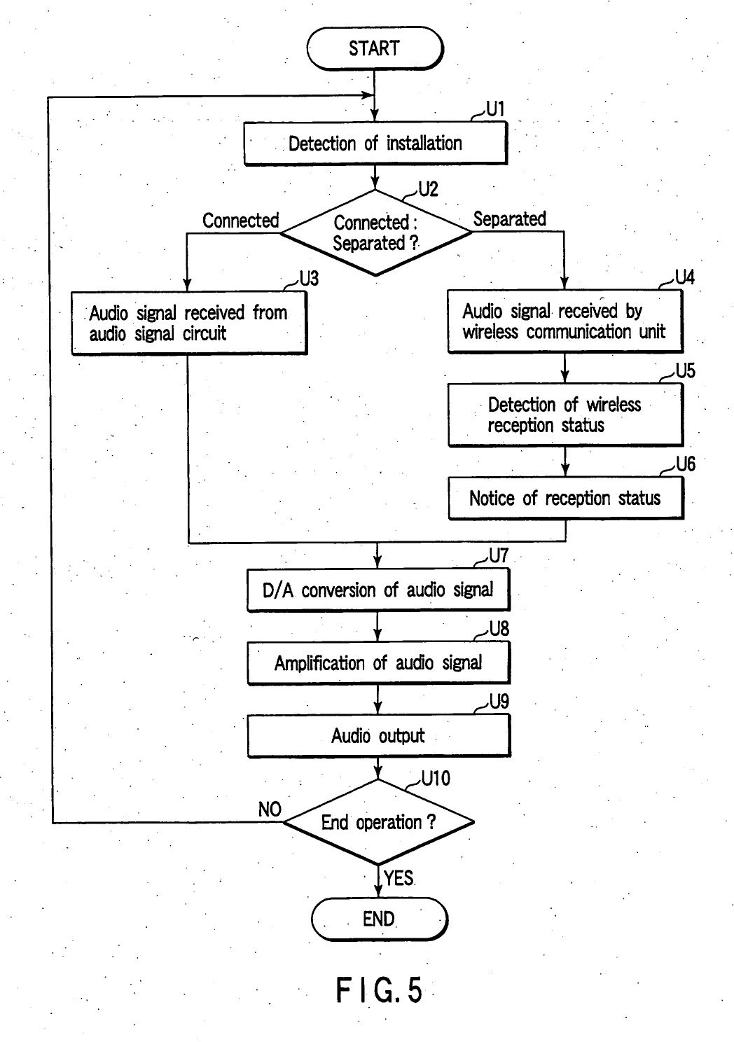

FIG. 5 shows a flow of an audio signal output operation of the speaker unit 2a.

In step U1, the installation detector 28 records installation result data 34 showing the result of detection of installation of the speaker unit 2a.

In step U2, the communication controller 31 of the speaker unit 2a determines whether the installation result data 34 shows installation or not.

If the installation result data 34 shows installation, the communication controller 31 sends the audio digital signal received through the audio signal circuit 20 to the D/A converter 32 in step U3.

On the other hand, if the installation result data 34 does not show installation, in step U4, the communication controller 31 sends the audio digital signal received through the wireless communication unit 16 to the D/A converter 32.

Then, the status detector 33 detects the reception status of the wireless communication unit 16 in step U5.

Next, the status notification unit 19a or the speaker 35 notifies the user of the status detected by the status detector 33 in step U6.

In step U7, the D/A converter 32 converts the audio digital signal from digital to analog signal, and sends it to the amplifier 17.

On receiving the analog signal, in step U8, the amplifier 17 amplifies the audio signal and sends it to the speaker 35.

Finally, the speaker 35 outputs sound according to the audio signal in step U9.

In step U10, the loudspeaker unit 2a repeats this process until the operation has finished.

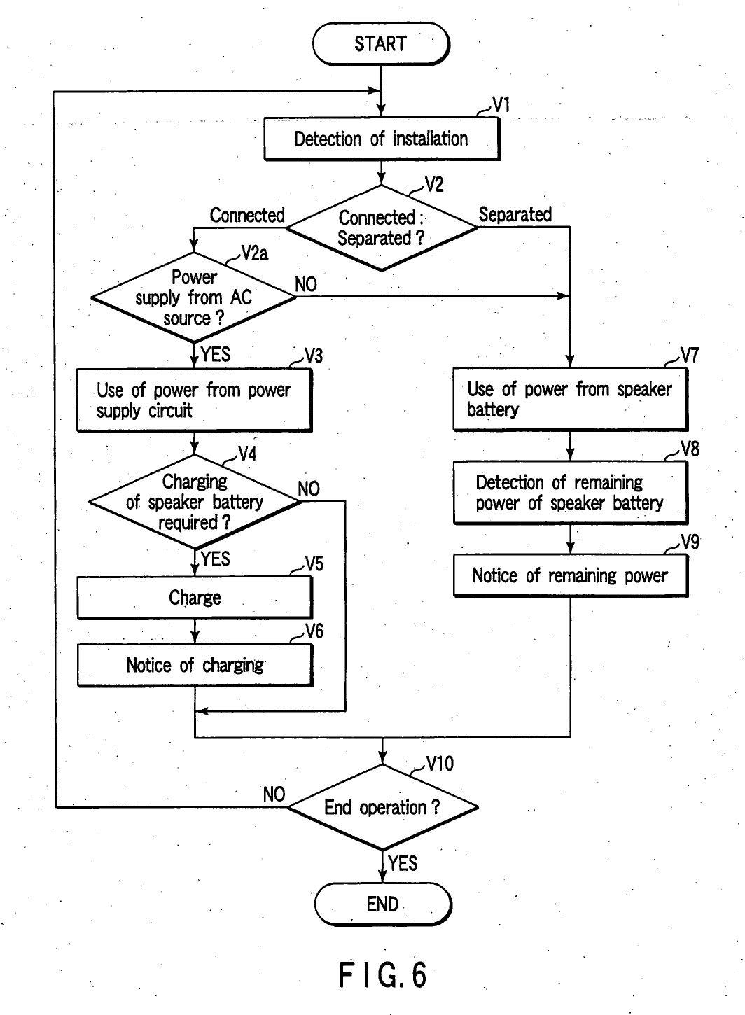

FIG. 6 shows a flow of a power supply operation in the speaker unit 2a.

In step V1, the installation detector 28 records installation result data 34 showing the result of detection of installation of the speaker unit 2a.

In step V2, the power supply controller 30 of the speaker unit 2a determines whether the installation result data 34 shows installation or not. In step V2a if the main body is being operated via battery, then the main body does not supply power on the circuit 21 and thus power to the speaker unit 2a is supplied from the speaker battery 18. If, however, the main body 101 is being operated via AC power, then the main body supplies power along circuit 21 and the process goes to step V3.

If the installation result data 34 shows installation, the power supply controller 30 provides the electric power supplied from the power supply circuit 21 to each device in step V3 except in the case that the main battery is used as a power supply to the main body.

In step V4, the power supply controller 30 determines if charging is necessary or not in the speaker battery 18.

If charging is necessary, the power supply controller 30 charges the speaker battery 18 by the electric power supplied from the power supply circuit 21 in step V5.

In step V6, the status detector 33 notices the charging process of the speaker battery 18 by using the status notification unit 19b.

On the other hand, if the installation result data 34 does not show installation in step V2, the power supply controller 30 provides the electric power supplied from the speaker battery 18 to each device in the speaker unit 2a in step V7.

Then, in step V8, the status detector 33 detects a remaining power state of the speaker battery 18.

In step V9, the status detector 33 provides an indication of the state detected in step V8 by using the status notification unit 19b or the speaker 35.

In step V10, the speaker unit 2a repeats this process until the operation has finished.

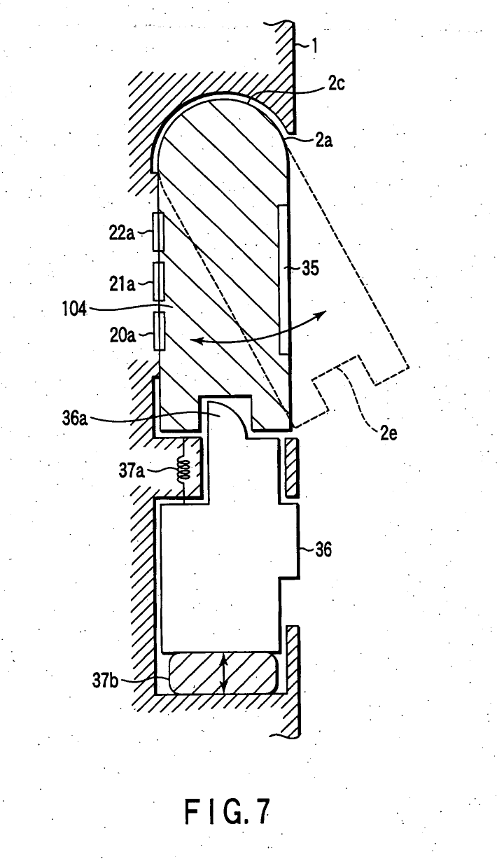

FIG. 7 shows mounting state of the speaker unit 2a on the main body 101.

The shape of the speaker unit 2a is like an approximately rectangular solid. One end of the speaker unit 2a is a curved 2c surface and another end is a concave surface 2e.

The shape of the accommodation space of the compartment 104 in the main body 101 is an approximately rectangular solid conforming to the speaker unit 2a. One end of the accommodation space is a shape conforming to the curved surface of the speaker unit 2a.

At another end of the accommodation space of the compartment 104, there is a slider 36 having a convex part or protruding part 36a. Elastic members 37a, such as spring or rubber shift the slider 36 to the accommodation space side so that the convex part may project into the accommodation space in the ordinary state. The slider 36 moves in the reverse direction of the accommodation space when putting the speaker unit 2a into the compartment 104 or taking out the speaker unit 2a from the compartment 104.

When accommodating the speaker unit 2a, first, the user inserts one end of the speaker unit 2a into the accommodation space. As a result, one end of the speaker unit 2a is opposite to one end of the accommodation space.

Next, the user rotates the speaker unit 2a to insert the other end of the speaker unit 2a into the accommodation space. As a result, the convex part 36a of the slider 36 and the convex surface 2e of the speaker unit 2a are engaged with each other.

When the speaker unit 2a is completely inserted into the accommodation space of the compartment 104, the connectors 20a, 21a, 22a are set in a connected state.

When taking out the speaker unit 2a, the user slides the slider 36 in a reverse direction of the accommodation space, and takes out the speaker unit 2a from the compartment 104.

In the embodiment described above, the speaker units 2a, 2b may be taken out from the main body 101 of the personal computer 1. Accordingly, the user may dispose the speaker units 2a, 2b at arbitrary positions, and may select the direction of the sound as desired, so that a favorable acoustic effect is achieved. Thus, even if the notebook PC 1 is reduced in size or thickness, the user may achieve a favorable acoustic effect. Furthermore, as the audio signal transmitted from the wireless communication unit 9 to the wireless communication unit 16 is digital so that audio signals may be transmitted and received favorably, the sound output by the speaker 35 maintain a high quality even though the personal computer 1 is used under electrically noisy environments.

In this embodiment, when the speaker units 2a, 2b are accommodated in the compartment 104, the speaker units are fixed. Hence, it is easy to carry the personal computer 1 containing the speaker units.

Also, in another embodiment, if the personal computer 1 is not provided with electric power from the AC power supply but the main body battery 14, the power supply controller 25 may be operated to supply power to the speaker unit but not to charge the speaker battery 18 of the speaker unit 2a, 2b even if the speaker unit 2a, 2b are installed in the main body 101. Therefore, this function saves power drain of the main body battery 14, and the saved battery power may be used by the other device, i.e. display device 103, CPU 4, and so on.

In this embodiment, the power supply state of the speaker units 2a, 2b, and the communication state between the main body 101 and speaker units 2a, 2b are detected and noticed to the user. Accordingly, the user easily knows the state of the speaker units 2a, 2b.

The present invention is not to be limited to the above-mentioned embodiment.

Various techniques may be applied in detection of attachment and detachment of the speaker units 2a, 2b. For example, when the speaker units 2a, 2b are installed in the main body 101, a circuit is connected physically between the speaker units 2a, 2b and the main body 101, and when the speaker units 2a, 2b are detached from the main body 101, the circuit is disconnected. The installation detectors 23, 28 may transmit and receive a call signal and response signal between the speaker units 2a, 2b and the main body 101 through such circuit. When the call signal and response signal cannot be transmitted or received, the installation detectors 23, 28 determine that the speaker units 2a, 2b are detached from the main body 101.

The installation detector 23 or power supply controller 25 of the main body 101 may be realized also by the operation of, for example, the CPU 4 or SB 7, instead of the EC 12.

Instead of the memory 24, the memory 5 or HDD 8 may be used.

The communication controller 27 of the main body 101 may be realized also by the operation of, for example, the EC 12 or CPU 4, instead of the SB 7.

The operation of the installation detector 23, power supply controller 25 or communication controller 27 of the main body 101 may be controlled by the utility program executed by the CPU. The utility program may display the remaining power of the speaker battery 18, the wireless communication state or attachment state between the main body 101 and the speaker units 2a, 2b by a display device 103 installed in the main body 101.

The main body 101 may be configured to hold the speaker units 2a, 2b when the speaker units 2a, 2b are pushed into the compartment 104, and releasing the speaker units 2a, 2b when the held speaker units 2a, 2b are further pushed in.

The distance between the main body 101 and the speaker units 2a, 2b may be detected by various methods, such as availability of wireless communications, and when it is determined that the distance exceeds a specified range, the speaker units 2a, 2b may sound a warning alert. As a result, loss of the speaker units 2a, 2b can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a main body;
a speaker unit detachably connected to said main body, said speaker unit having a speaker, a first wireless communication unit, and a D/A converter;
a second wireless communication unit which transmits an audio digital signal to the first wireless communication unit over a wireless cannel;
a detector which detects whether or not said speaker unit is installed in said main body; and
a controller which actuates said second wireless communication unit to transmit the audio digital signal to the first wireless communication unit when said detector detects that said speaker unit is not installed in said main body,
wherein the D/A converter converts the audio digital signal received by the first communication unit to an audio analog signal, and the speaker outputs sound on the basis of the audio analog signal.

2. An electronic apparatus according to claim 1, wherein said main body includes a connector to be electrically connected to said speaker unit, and
said controller operative for transmitting said audio digital signal to the D/A converter in said speaker unit by way of said connector when said speaker is connected to said main body by said connector.

3. An electronic apparatus according to claim 1, wherein said speaker unit includes:
a second detector which detects whether or not said speaker is installed in said main body;
a battery; and
a power supply controller which supplies electric power from said battery to the first wireless communication unit when said second detector does not detect that said speaker unit is installed in said main body.

4. An electronic apparatus according to claim 3, wherein said power supply controller stops supplying electric power to the first wireless communication unit when said second detector detects that said speaker is installed in said main body.

5. An electronic apparatus according to claim 3, wherein said power supply controller charges said battery by the electric power supplied from said main body when said second detector detects that said speaker unit is installed in said main body.

6. An electronic apparatus according to claim 3, wherein said speaker unit includes:
a status detector which detects the remaining power of said battery; and
a status notification unit which provides a notification of the remaining power of said battery detected by said status detector.

7. An electronic apparatus according to claim 1, wherein said speaker unit includes:
a status detector which detects the communication status of wireless communications of the first wireless communication unit; and
a status notification unit which provides a notification of the communication status detected by said status detector.

8. An electronic apparatus according to claim 1, wherein said main body includes:
a power supply controller which supplies electric power to said speaker unit when said main unit receives power from an outside power source, and which does not supply electric power to said speaker unit when said main unit does not receive power from the outside power source.

9. An electronic apparatus in which a speaker unit is detachably mounted, comprising:
a main body in which the speaker unit is detachably mounted;
a connector arranged in said main body and which electrically connects with said speaker unit when said speaker unit is mounted in said main body:
a wireless communication unit; and
a communication controller which transmits an audio digital signal through one of said connector and said wireless communication unit.

10 An electronic apparatus according to claim 9, further comprising:
a detector which detects that the speaker unit is mounted in said main body; and
said communication controller operable for transmitting the audio digital signal through said connector when said detector detects that the speaker is mounted in said main body, and for transmitting the audio digital signal through said wireless communication unit when said detector does not detect that the speaker unit is mounted in said main body.

11. A speaker unit, comprising:
a wireless communication unit which receives an audio digital signal over a wireless connection;
a connector which receives the audio digital signal over a wired connection;
a D/A converter coupled to said wireless communication unit and said connector; and
a speaker coupled to said D/A converter.

12. A method for outputting an audio digital signal from an electronic device to a speaker unit detachably installed in the electronic device, the electronic device and the speaker unit operative for wireless communication with each other over wireless connection, comprising:
detecting whether or not the speaker unit is installed in the electronic device, and
transmitting an audio digital signal to the speaker unit through the wireless connection when it is detected that the speaker unit is not installed in the electronic device.

13. A method for outputting an audio digital signal according to claim 12, further comprising
transmitting an audio digital signal to the speaker unit by way of a connector electrically connected to the speaker unit when it is detected that the speaker unit is installed in the main body.

14. A method for outputting an audio digital signal according to claim 12, further comprising
supplying electric power for the wireless communication from a battery of the speaker unit when it is detected that the speaker unit is not installed in the electronic device.

15. A method for outputting an audio digital signal according to claim 14, further comprising
stopping the supply of electric power supply for the wireless communication from the battery when it is detected that the speaker unit is installed in the electronic device.

16. A method for outputting an audio digital signal according to claim 14, further comprising:
determining whether or not said electronic device receives electric power from a battery within said electric device and an outside power source connected to said electronic device; and
charging the battery with the electric power supplied from the electronic device when it is detected that the speaker unit is installed in the electronic device and the electronic device receives the electronic power from the outside power source.

17. A method for outputting an audio digital signal according to claim 12, further comprising
detecting the communication status of the wireless communications in the speaker unit, and
providing an indication of the detected communication status.

18. A method for outputting an audio digital signal according to claim 12, further comprising
detecting in the electronic device that electric power is supplied from a commercial power source to said electronic device, and
supplying electric power to the speaker unit the electronic device when the electric power is supplied from the commercial power source to the electronic device and it is detected that the speaker unit is installed in the electronic device.

19. A method for outputting an audio digital signal according to claim 18, further comprising
stopping supplying the electric power to the speaker unit when the electric power is not supplied from the commercial power source even though it is detected that the speaker unit is installed in the electronic device.

20. A method as recited in claim 19 further comprising supplying electric power to operate said speaker unit from a battery installed in said speaker unit.
